(19) United States
(12) Patent Application Publication
(10) Pub. No.: US 2002/0053143 A1
(43) Pub. Date: May 9, 2002

(54) Measuring instrument for establishing the mounting lens angle of a spectacle frame

(76) Inventor: Jorg Fuhrmann, Gilching (DE)

Correspondence Address: ST. ONGE STEWARD JOHNSTON & REENS, LLC, 986 BEDFORD STREET, STAMFORD, CT, 06905-5619, US

(21) Appl. No.: 10/032,954

(22) Filed: Dec. 28, 2001

Related U.S. Application Data
(63) Continuation of application No. PCT/DE01/01606, filed on Apr. 30, 2001.

(30) Foreign Application Priority Data
Apr. 28, 2000 (DE) 100 20 844.4

(51) Int. Cl. G01B 5/24

(52) U.S. Cl. 33/200

(57) ABSTRACT

The present invention relates to a measuring instrument for establishing the mounting lens angle of a spectacle mount, comprising

a support on which the spectacle lens with the upper or the lower groove base may be placed and which presents a marker by which the spectacle lens is oriented, and

at least one adjustable means measuring the angle enclosed between the connecting line from the nasal groove base to the temporal groove base of a lens ring, on the one hand, and the marker, on the other hand.

This application is a continuation of pending International Application PCT/DE01/01606 filed Apr. 30, 2001, which designates the United States and claims priority from German Application 10020844.4 filed on Apr. 28, 2000.

### FIELD OF THE INVENTION

The present invention relates to measuring instrument for establishing the mounting lens angle of a spectacle frame.

Due to the advances achieved in computer technology and on account of the development of automatic optimizing programs for spectacle frames with a progressive effect, as well as in view of the development of highly flexible numerically controlled grinding and polishing machinery, it has become possible to compute and manufacture spectacle frames of which each is produced in correspondence with the individual data of a certain wearer of the glasses. It is known that apart from the usual prescribed values parameters such as the pupil spacing, the eye length, the forward inclination and Shelling, the length or dioptric ametropia, vertical and/or horizontal prisms as well as their right/left subdivision, the size and/or the shape of the selected mount, the centering height, the pupil diameter and/or the forward inclination of the lenses are also considered as individual parameters in the computation of the progressive surface(s).

When the fit of the pre-adapted correction mount, which has been selected by a particular wearer of the glasses, is equally considered in the optimization of the continuous vision lenses it becomes necessary to measure spacings and angles of the correction mount relative to the face of the spectacle wearer.

In accordance with the present invention it has now been found that the bend of the bridge and hence the tilt of the lens rings takes such a strong influence on the astigmatism of oblique bundles that the latter must be taken into consideration within the general framework of an individualized optimization. It is thus necessary to measure the so-called mounting lens angle. The mounting lens angle is descriptive of the lateral tilt of the individual lens mount ahead of the eye of the spectacle wearer.

### PRIOR ART

For the measurement of the mounting lens angle, i.e. the angle by which the individual lens mount (mounting lens) is tilted relative to the “horizontal tangent” towards the center of the bridge of the mounting, so far measuring means have not yet become known which are suitable to measure this angle especially. The measuring means described in the technical literature serve exclusively to measure the deflection of the mount.

In the pamphlet “Anatomic Spectacle Adaptation” by Johannes Eber, published by “Optische Fachveroeffentlichungen GmbH” in Heidelberg in 1987, the fact is described that in the case of major lenses a spectacle mount presents a certain deflection. In that brochure, merely the manner is discussed in which the mount is adapted, but not the influence of this deflection on the optical properties of the spectacle lens.

### BRIEF DESCRIPTION OF THE INVENTION

The present invention is based on the problem of providing a measuring instrument for establishing the mounting lens angle of a spectacle mount.

One inventive solution to this problem is defined in patent claim 1. Improvements of the invention are the subject matters of claims 2 et seq.

In accordance a measuring instrument is created that comprises a support onto which the spectacle lens can be placed with the upper or the lower groove base of the lens ring. The support or the respective bottom plate, respectively, has a marker relative to which the spectacle lens is oriented. Moreover, the inventive measuring instrument comprises at least one adjustable means measuring the angle that is enclosed by the connecting line from the nasal groove base to the temporal groove base of a lens ring, on the one hand, and the marker, on the other hand.

### BRIEF DESCRIPTION OF THE DRAWING

In the following, the invention will be described, without any limitation of the general inventive idea, by exemplar embodiments with reference to the drawing that is, in all other respects, explicitly referred to as far as the disclosure of all inventive particulars is concerned which are not explained in more details in the text. In the drawing:

FIGS. 1a and 1b show a first embodiment of the invention, and

FIGS. 2a to 2c illustrate a second embodiment of the invention.

### DESCRIPTION OF EMBODIMENTS

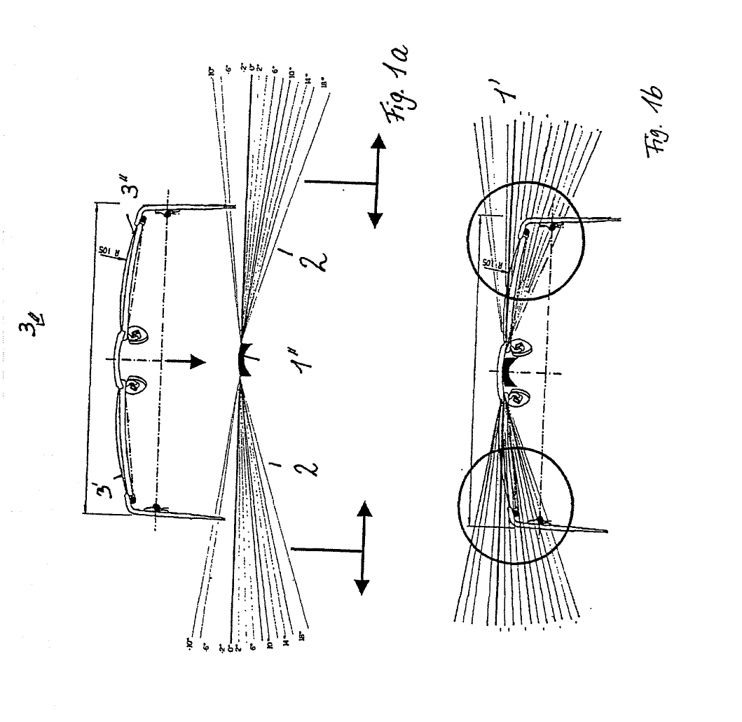

FIGS. 1a and 1b illustrate a first embodiment of the invention wherein the tilt ahead of the eye is directly measured on each side of the mount. In this embodiment, two adjustable means are provided on a supporting plate. Each of the two means is a fan of angles 2 that is adapted to be horizontally displaced along the marker 1′ applied on the supporting plate. It is therefore possible that each fan of angles 2 may be centered by its origin on the nasal groove base of a lens ring 3′ or 3″, respectively, of the mount 3.

The first embodiment of the invention is employed for measurement as follows:

A mount 3 of any type whatsoever is placed on the bridge support 1″ of the supporting plate. The two fangs of angles 2, which are horizontally displaceable, are now centered such that their origin is located on the nasal groove base of the mount 1. The tilt is then read on the respective temporal groove base, specifically at the point where it intersects with a line of the fan. Circles in FIG. 1b symbolically indicate this. Based on estimation by the sight and on account of a flexible adjustability it is possible to implement a measuring accuracy of ±1° approximately.

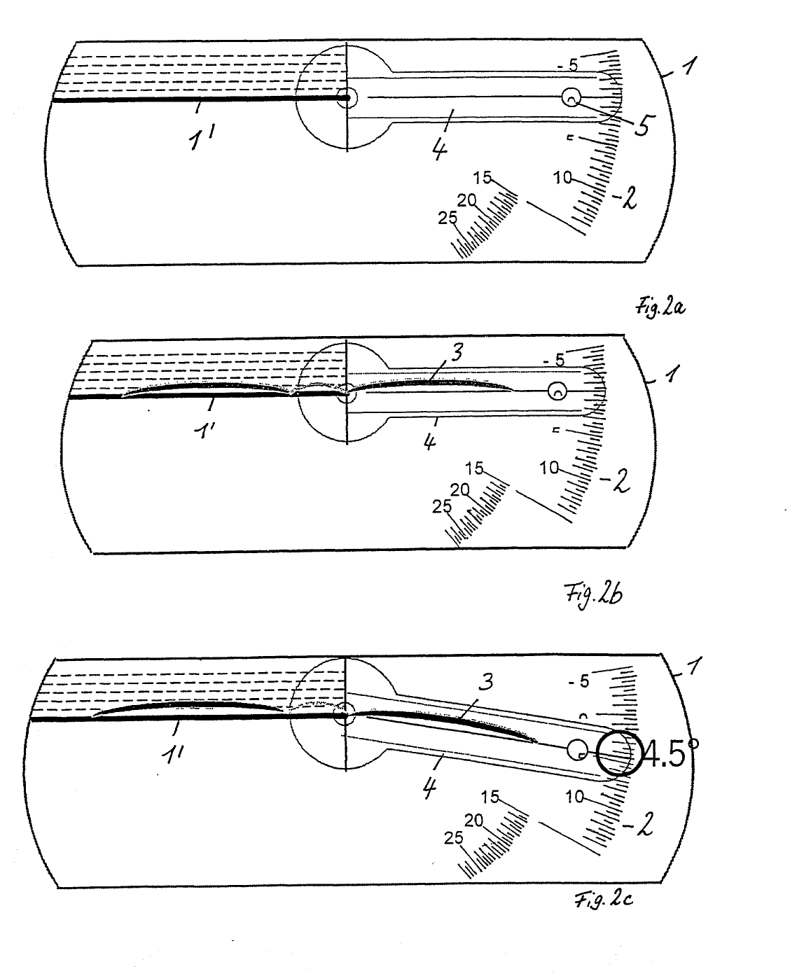

FIGS. 2a, 2b and 2c illustrate a second embodiment of the invention wherein a pre-adjustable means is provided that comprises a pointer 4 rotatable about a point of the marker 1′, which an angular scale 2 is associated with. The pointer 4 includes a magnifier 5 for reading the angular scale 2. This embodiment is based on the assumption that the ophthalmic optician will adapt the correction mount as symmetrically as possible to the spectacle wearer. For this reason, a compromise is accepted in this embodiment because merely the deflection of the correction mount as a whole is measured. The tilt of the individual glass mounts is established as mean value from the tilt value on one side whereas the other side of the spectacle mount is oriented in the zero direction, which means that it is oriented by its nasal and temporal groove base in parallel with the horizontal lines. The lettering of the angular scale 2 takes already the fact into consideration that the tilt of a lens ring corresponds to half the value of the measured amount.

FIG. 2b illustrates the case that a mount 3 is placed onto the supporting plate 1 without any tilt.

FIG. 2c shows the case that a deflected mount 3 is placed onto the supporting plate 1. With this combination it should be noted that the nasal groove base of the right lens ring is located in the origin of the measuring pointer 4. The deflecting angle of the pointer 4 amounts to 9° in this case. For this reason, the scaling indicates 4.5° so as to facilitate the ordering procedure for the ophthalmic optician.

1. Measuring instrument for establishing the mounting lens angle of a spectacle mount, comprising
a support on which the spectacle lens with the upper or the lower groove base may be placed and which presents a marker by which the spectacle lens is oriented, and
at least one adjustable means measuring the angle enclosed between the connecting line from the nasal groove base to the temporal groove base of a lens ring, on the one hand, and the marker, on the other hand.

2. Measuring instrument according to claim 1,
characterized in that two adjustable means are provided whereof each comprises a fan of angles that is adapted to be horizontally displaced along said marker in such a way that it is possible to center each fan of angles by its origin on the nasal groove base of a lens ring of the mount.

3. Measuring instrument according to claim 1
characterized in that a pre-settable means is provided that comprises a pointer rotatable about a point of said marker and which an angular scale is associated with.

4. Measuring instrument according to claim 3,
characterized in that said pointer comprises a magnifier for reading said angular scale.
